(19) United States
(12) Patent Application Publication
(10) Pub. No.: US 2004/0164665 A1
(43) Pub. Date: Aug. 26, 2004

(54) Display device

(76) Inventors: Susumu Sasaki, Chiba (JP); Yoshiyuki Kaneko, Hachoiji (JP); Shigemi Hirasawa, Chiba (JP); Makoto Okai, Tokorozawa (JP); Hiroshi Kawasaki, Ooamishirasato (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/781,695

(22) Filed: Feb. 20, 2004

(30) Foreign Application Priority Data
Feb. 21, 2003 (JP) 2003-044057

(51) Int. Cl. H01J 1/62

(52) U.S. Cl. 313/495

(57) ABSTRACT

A display device includes a face substrate which has anodes and phosphors on an inner surface thereof, a back substrate which has cathode lines and electron sources formed on the cathode lines, a support body which is interposed between both substrates in a state that the support body surrounds a display region and forms a given inner space, and a sealing material which hermetically seals the support body and both substrates. To enable the display device to perform a high quality display and to have a long lifetime while ensuring the conduction in a wide range between the cathode lines and the electron sources, the cathode lines are made of a material having a conductor and an insulator and the composition of a connecting portion between the cathode line and the electron source is formed such that a conductor occupancy rate becomes equal to or more than an insulator occupancy rate.

### BACKGROUND OF THE INVENTION

1. Field of the Invention

The present invention relates to a display device which utilizes an emission of electrons into a vacuum which is defined between a face substrate and a back substrate, and more particularly, to a display device which exhibits the excellent characteristics in emitting electrons from an electron source.

2. Description of the Related Art

As a display device which exhibits the high brightness and the high definition, color cathode ray tubes have been popularly used conventionally. However, along with the recent request for the higher quality of images of information processing equipment or television broadcasting, the demand for planar displays (panel displays) which are light in weight and require a small space while exhibiting the high brightness and the high definition has been increasing.

As typical examples, liquid crystal display devices, plasma display devices and the like have been put into practice. Further, particularly, as display devices which can realize the higher brightness, it is expected that various kinds of panel-type display devices including a display device which utilizes an emission of electrons from electron sources into a vacuum and is referred to as an electron emission type display device or a field emission type display device and an organic EL display which is characterized by low power consumption will be commercialized.

Among such panel type display devices, as the above-mentioned field emission type display device, a display device having an electron emission structure which was invented by C. A. Spindt et al, a display device having an electron emission structure of a metal-insulator-metal (MIM) type, a display device having an electron emission structure which utilizes an electron emission phenomenon based on a quantum theory tunneling effect (also referred to as “surface conduction type electron source), and a display device which utilizes an electron emission phenomenon having a diamond film, a graphite film and carbon nanotubes and the like have been known.

Among these panel type display devices, the field emission type display device is formed by laminating and sealing a front panel which forms an anode electrode and a fluorescent material layer on an inner surface thereof and a back panel which forms electron emission type cathodes and grid electrodes which constitute control electrode on an inner surface thereof with a distance of not less than 0.5 mm, for example, therebetween, wherein a sealed space is formed between both panels and the sealed space is evacuated to a pressure lower than an ambient atmospheric pressure or to a vacuum.

Recently, the use of carbon nanotubes (CNT) as a field emission type electron source which constitutes the cathodes of this type of planar display has been studied. Carbon nanotubes are extremely thin needle-like carbon compound (to speak strictly, a so-called graphene sheet in which carbon atoms are coupled in a hexagonal shape is formed in a cylindrical shape). A carbon nanotubes assembly which is formed by collecting a large number of carbon nanotubes is fixed to a cathode electrode. By applying an electric field to the cathode electrode having the carbon nanotubes, it is possible to emit electrons of high density from the carbon nanotubes at a high efficiency whereby it is possible to constitute a flat panel display which is capable of displaying various images of high brightness by exciting a phosphor with these electrons.

FIG. 13 is a schematic view for explaining the basic structure of the field emission type display. CNT is the carbon nanotubes formed on a cathode (cathode electrode) K, A indicates an anode (anode electrode), and a phosphor PH is formed on an inner surface of the anode A. A grid electrode G which controls the emission of electrons is formed in the vicinity of the cathode K and a voltage Vs is applied between the cathode K and the grid electrode G so as to emit electrons from the carbon nanotubes CNT. By applying a high voltage Eb between the cathode K and the anode A, the electrons e emitted from the carbon nanotubes CNT are accelerated and the phosphor PH is excited whereby a color light L which is dependent on the composition of the phosphor PH is irradiated. Then, by controlling a quantity of electrons which are emitted from the modulation voltage Vs given to the grid electrode G formed in the vicinity of the cathode K, for example, the brightness of the color light L can be controlled.

FIG. 14 is a schematic cross-sectional view for explaining the constitutional example of the field emission type display. In this field emission type display (FED), a back substrate 1 which is formed of a glass plate and a face substrate 2 which is also formed of a glass plate are laminated to each other by way of a frame-like support body 3 which is interposed between both substrates 1, 2 in a state that the support plate 3 has a height of approximately 1 mm, for example, and surrounds a display region for holding a given distance between both substrates 1, 2. Further, an inside hermetic space is evacuated and sealed. Cathode lines 13, insulation layers 14 and grid electrodes 15 are formed on an inner surface of the back substrate 1, while anode electrodes 11 and phosphors 12 are formed on an inner surface of the face substrate 2. Carbon nanotubes of electron sources not shown in the drawing are provided to the cathode lines 13.

FIG. 15 is a schematic plan view as viewed from the back substrate 1 side of the field emission type display shown in FIG. 14. In the inside of the effective display region AR on the inner surface of the face substrate 2, phosphors R, G, B of three colors are arranged. In this example, respective pixels are defined by partitions 16. In a monochromic display, all phosphors are formed in the same color.

With respect to the above-mentioned display which uses carbon nanotubes, literatures such as non-patent literature 1 (“Large Size FED with Carbon Nanotube Emitter” Sashiro Uemura et al., SID 02 DIGEST(2002), pp. 1132-1135), non-patent literature 2 (Fully sealed, high-brightness carbon-nanotube field-emission display”., W. B. Choi et al., Appl. phys. Lett., VOL. 75, NO. 20, (1999), pp. 3129-3131) and the like are known. A field emission type display disclosed in these literatures is configured such that a carbon nanotube paste which is obtained by forming carbon nanotube powder into a paste or a carbon nanotube-metal mixture paste which is formed by mixing carbon nanotube powder and metal powder is printed on a glass substrate and gate electrodes which constitute pull-out electrodes (or control electrodes) and a fluorescent surface which emits light upon incidence of the pulled-out light are arranged on an upper surface of the printed paste.

Further, as a prior art related to cathodes which constitute electron emitting portions in this type of panel display, a technique in which the electron emitting portions are constituted of carbon nanotubes formed of cylindrical graphite layers is disclosed in patent literature 1 (Japanese Unexamined Patent Publication Heill (1999)-162383. Further, patent literature 2 (Japanese Unexamined Patent Publication 2000-36243) discloses a method for forming an electron emission portion in which a paste which is formed by mixing bundles each of which is a mass of carbon nanotubes into a tacky solution having conductivity is formed into a pattern and laser beams are irradiated to the pattern thus making the carbon nanotubes emit electrons in a state that carbon nanotubes are projected from a surface of the pattern.

Further, patent literature 3 (Japanese Unexamined Patent Publication 2000-90809) discloses a technique which forms field emission cathodes by adhering a bundle of carbon nanotubes to a substrate using a conductive resin as a prior art. Still further, patent literature 4 (Japanese Unexamined Patent Publication 2000-251783) discloses the constitution in which a resistance layer formed of a ruthenium oxide mixture film or an a-Si thin film is applied to a cathode electrode formed of a strip-like conductor and an emitter made of a field emission material such as carbon nanotubes is formed on the resistance layer. Further, patent literature 5 (Japanese Unexamined Patent Publication 2001-283716), patent literature 6 (Japanese Unexamined Patent Publication 2002-157951) and the like disclose a technique which embeds a portion of carbon nanotubes into a metal plating layer formed on a support substrate and uses projecting portions as an emitter.

### SUMMARY OF THE INVENTION

The above-mentioned electron emission type display device is of a type in which the display is performed by making electrons emitted from the electron sources pass through apertures formed in the control electrodes and impinge on the phosphors which constitute the anodes so as to make the phosphors excite and generate light. This display device provides the excellent structure which enables the light-weighted and space-saving planar display while having excellent characteristics such as high brightness and high definition. However, in spite of such excellent constitution, the display device still has tasks to be solved which will be described later. That is, in the flat panel display such as the above-mentioned FED or the like, positions where electron source does not perform the electron emission are present in spots on some portions of a surface of an electron source and hence, the electron emission is performed in a mottled pattern. Accordingly, there arises a drawback that it is difficult to always obtain the uniform electron emission from the whole surface of the electron source. There also arises a drawback that an electron emission quantity per se becomes insufficient. When the electron emission quantity becomes insufficient and non-uniform, the brightness of a video screen also becomes insufficient and hence, it is difficult to ensure the display quality. Accordingly, there arise drawbacks such as a drawback that it is difficult to obtain the high quality display and a drawback that the exhaustion of the electron source is accelerated thus impeding the acquisition of the long lifetime. These drawbacks constitute tasks to be solved by the present invention.

Accordingly, it is an object of the present invention to provide a display device capable of a desired high-quality display and having a long lifetime by solving the above-mentioned various drawbacks.

To achieve the above-mentioned object, the representative constitution of the present invention is characterized by the improvement of the structure which connects cathode lines and electron sources. Hereinafter, the representative constitutions of the display device of the present invention are described.

That is, the display device according to the present invention comprises a face substrate which forms anodes and phosphors on an inner surface thereof, a plurality of cathode lines which extend in one direction and are arranged in parallel in another direction which crosses one direction and have electron sources, control electrodes which face the cathode lines in a display region and have electron passing apertures for allowing electrons from the electron sources to pass through the electron passing apertures to the face substrate side, a back substrate which forms the control electrodes and the cathode lines on an inner surface thereof and faces the face substrate in an opposed manner with a given distance therebetween, a support body which is interposed between the face substrate and the back substrate in a state that the support body surrounds the display region and holds the given distance, and a sealing material which hermetically seals end faces of the support body and the face substrate and the back substrate respectively, wherein a connecting portion of the cathode line with the electron source has a composition which includes a conductor and an insulator, and an occupancy rate of the conductor in the composition is set equal to or more than an occupancy rate of the insulator in the composition.

Further, the display device according to the present invention may be constituted such that the occupancy rate of the insulator is less than 50% and a surface of the back substrate in the vicinity of the cathode lines exhibits an uneven shape.

That is, the display device according to the present invention comprises a face substrate which forms anodes and phosphors on an inner surface thereof, a plurality of cathode lines which extend in one direction and are arranged in parallel in another direction which crosses one direction and have electron sources, control electrodes which face the cathode lines in a display region and have electron passing apertures for allowing electrons from the electron sources to pass through the electron passing apertures to the face substrate side, a back substrate which forms the control electrodes and the cathode lines on an inner surface thereof and faces the face substrate in an opposed manner with a given distance therebetween, a support body which is interposed between the face substrate and the back substrate in a state that the support body surrounds the display region and holds the given distance, and a sealing material which hermetically seals end faces of the support body and the face substrate and the back substrate respectively, wherein a layer having a high conductor occupancy rate is interposed in a connecting portion between the cathode line and the electron source.

Further, the display device according to the present invention may be constituted such that the layer in which the conductor has the high occupancy rate is a silver particle layer or a gold particle layer.

Due to the above-mentioned constitutions, it is possible to provide the display device which can perform the high quality display and can have the long lifetime.

Here, the present invention is not limited to the above-mentioned constitution and the constitution of embodiments described later and various modifications can be made without departing from the technical concept of the present invention.

### BRIEF DESCRIPTION OF THE DRAWINGS

FIG. 1A and FIG. 1B are explanatory views of the schematic constitution showing one embodiment of a display device according to the present invention, wherein FIG. 1A is a schematic plan view as viewed from a face substrate side and FIG. 1B is a schematic side view as viewed from the direction indicated by an arrow A in FIG. 1A;

FIG. 2A and FIG. 2B are explanatory views of a constitutional example of a back substrate of the display device shown in FIG. 1A and FIG. 1B, wherein FIG. 2A is a schematic plan view as viewed from above in the z direction and FIG. 2B is a schematic side view as viewed from the direction indicated by an arrow B in FIG. 2A;

FIG. 3 is. a schematic perspective view showing an essential part of one embodiment of the display device according to the present invention shown in FIG. 1A and FIG. 1B as well as in FIG. 2A and FIG. 2B in an enlarged manner;

FIG. 4 is a schematic cross-sectional view showing an essential part in FIG. 3;

FIG. 5 is a schematic cross-sectional view showing an essential part in FIG. 4 in an enlarged manner;

FIG. 6 is a schematic cross-sectional view of another embodiment of the display device according to the present invention and corresponds to FIG. 5;

FIG. 7 is a schematic cross-sectional view further showing an essential part of another embodiment of the display device according to the present invention in an enlarged form;

FIG. 8 is a view showing the relationship between the property and the light emitting uniformity of a connecting portion of a cathode line to explain the present invention;

FIG. 9 is a SEM photograph showing a surface of the cathode line to explain the present invention;

FIG. 10 is a SEM photograph showing a surface of one example of the cathode line used in the display device of the present invention;

FIG. 11 is a SEM photograph showing a surface of another example of the cathode line used in the display device of the present invention;

FIG. 12 is an explanatory view of an example of an equivalent circuit of the display device according to the present invention;

FIG. 13 is a schematic view for explaining the basic constitution of a field emission type display;

FIG. 14 is a schematic cross-sectional view for explaining a constitutional example of a field emission type display; and

FIG. 15 is a schematic plan view of a field emission type display shown in FIG. 14.

### DESCRIPTION OF THE PREFERRED EMBODIMENTS

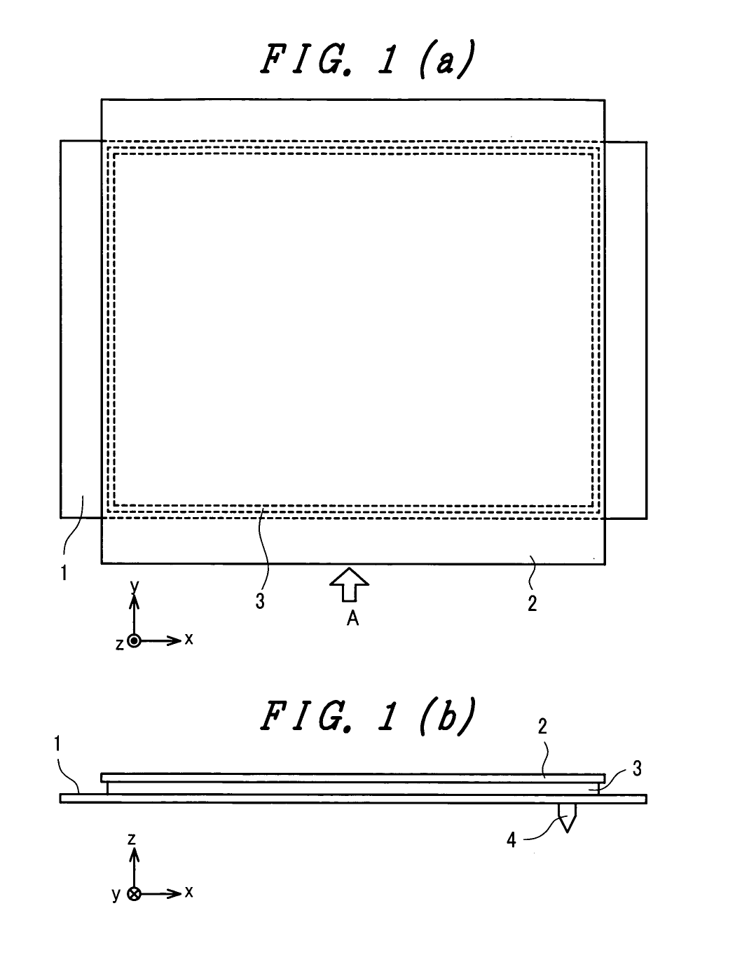

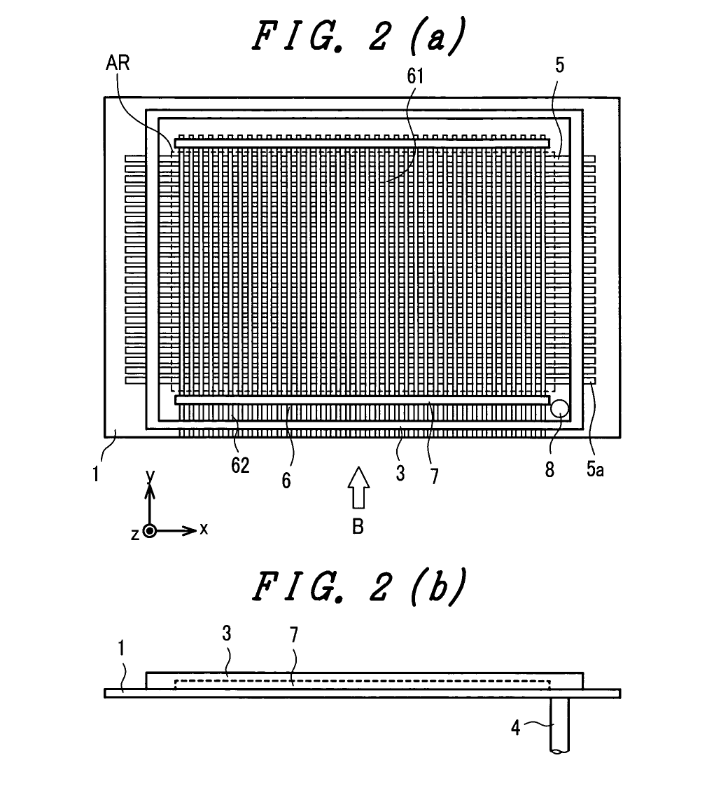

Preferred embodiments of the present invention are explained in detail hereinafter in conjunction with drawings which show these embodiments. FIG. 1A and FIG. 1B are explanatory views of the schematic constitution of a field emission type display device showing one embodiment of a display device according to the present invention, wherein FIG. 1A is a plan view as viewed from a face substrate side, FIG. 1B is a side view as viewed from the direction indicated by an arrow A in FIG. 1A. FIG. 2A and FIG. 2B are schematic explanatory views of a constitutional example of a back substrate constituting the display device shown in FIG. 1A and FIG. 1B, wherein FIG. 2A is a plan view as viewed from above in the z direction and FIG. 2B is a side view as viewed from the direction indicated by an arrow B in FIG. 2A.

In FIG. 1A and FIG. 1B as well as in FIG. 2A and FIG. 2B, numeral 1 indicates a back substrate, numeral 2 indicates a face substrate, numeral 3 indicates a support body which also functions as an outer frame, and numeral 4 indicates an exhaust pipe (in a sealed state). Further, numeral 5 indicates cathode lines, numeral 6 indicates control electrodes, numeral 7 indicates electrode pressing members, and numeral 8 indicates an exhaust port, wherein the exhaust port 8 is formed in the back substrate 1 and is communicated with the exhaust pipe 4. Here, the exhaust pipe 4 is shown in a pre-sealed state in FIG. 2. The back substrate 1 is constituted of an insulation substrate which is preferably made of glass or ceramic such as alumina in the same manner as the face substrate 2 and has a film thickness of several mm, for example, 3 mm. The face substrate 2 and the back substrate 1 are stacked in the z direction. Here, the z direction indicates a direction which is orthogonal to substrate surfaces of the back substrate 1 and the face substrate 2. On an inner surface of the back substrate 1, a plurality of cathode lines 5 having the constitution described later extend in one direction (the x direction) and are arranged in parallel in another direction (the y direction). End portions of the cathode lines 5 are pulled out to the outside of the support body 3 as lead lines 5a of the cathode lines 5.

Above the cathode lines 5, the control electrodes 6 which are formed of a plurality of strip-like electrode elements 61 are arranged, wherein the plurality of strip-like electrode elements 61 are insulated from the cathode lines 5, extend in the y direction and are arranged in parallel in the x direction. Further, at an outer periphery of a gap defined between opposing surfaces of the back substrate 1 and the face substrate 2, the support body 3 is interposed. A sealing material is interposed between both end surfaces of the support body 3 and both substrates 1, 2 thus hermetically sealing an inside surrounded by the support body 3 and both substrates 1, 2. Then, by evacuating the inside through the exhaust pipe 4, a given degree of vacuum is created in the inside. The above-mentioned hermetic sealing is performed such that the inside is heated in a nitrogen atmosphere, for example, at a temperature of approximately 430° C., for example, and thereafter, the inside is evacuated while being heated at a temperature of approximately 350° C., for example thus sealing the inside in a vacuum state.

Here, as the sealing material, for example, a glass material which has the composition of 75 to 80 wt % of PbO, approximately 10 wt % of B₂O₃ and 10 to 15 wt % of balance and contains amorphous type frit glass can be preferably used.

Further, unit pixels are formed on crossing portions of the cathode lines 5 and the control electrodes 6 in a matrix array and the above-mentioned display region is formed of these pixels arranged in the matrix array. In general, the above-mentioned three unit pixels form a group and constitute a color pixel consisting of red (R), green (G) and blue (B).

Here, the control electrodes 6 are constituted by arranging a large number of strip-like electrode elements (metal ribbons) 61 having electron passing holes in parallel and are proposed by inventors of the present invention in the course of development arriving at the present invention.

The control electrodes 6 may be manufactured in a separate step as separate parts. The control electrodes 6 are arranged above (the face substrate 2 side) and close to the cathode lines 5 which have electron sources and, at the same time, have portions thereof in the vicinity of both end portions thereof fixed to the back substrate 1 by the electrode pressing members 7 or the like which are arranged outside a display region AR and inside the support body 3 and are made of an insulator such as a glass material or the like. Further, the lead lines 62 are connected to the control electrodes 6 in the vicinity of the electrode pressing members 7 or in the vicinity of the support body 3 and these lead lines 62 are pulled out to an outer periphery of the display device and are connected to external circuits. The lead lines 62 may be formed by directly extending the strip-like electrode elements 61.

The control electrodes 6 having such a constitution can, compared to the structure in which control electrodes are formed by forming metal thin films on an insulation layer by vapor deposition, easily set a gap defined between the control electrodes and the cathode lines 5 uniform and hence, the control characteristics of respective pixels can be made uniform over the whole area of the display region thus enabling the acquisition of the high quality video display.

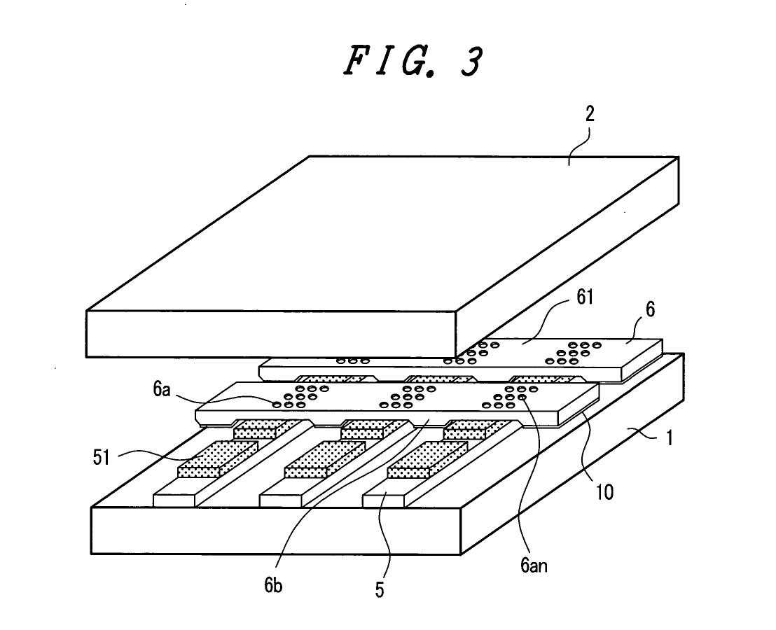

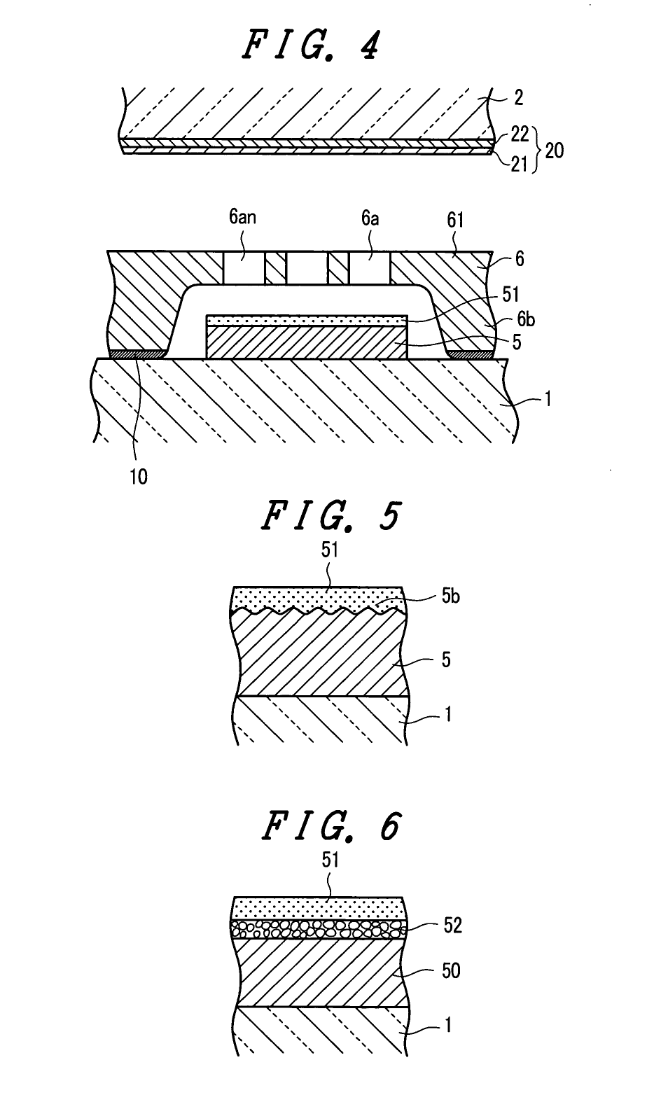

Next, FIG. 3 is a schematic perspective view showing an essential part of a field emission type display device which is one embodiment of the display device according to the present invention shown in FIG. 1A and FIG. 1B as well as in FIG. 2A and FIG. 2B in an enlarged form, while FIG. 4 is a schematic cross-sectional view showing an essential part in FIG. 3 and shows a vertical cross section in the direction (the y direction) orthogonal to the extending direction (the x direction) of the cathode lines 5 in FIG. 3. Numerals in FIG. 3 and FIG. 4 equal to the numerals used in FIG. 1A and FIG. 1B as well as in FIG. 2A and FIG. 2B indicate identical functional portions. In FIG. 3 and FIG. 4, the formation of the cathode lines 5 may adopt either one of a method which forms the cathode lines 5 by a vacuum thin film forming process as represented by a vapor deposition method or a sputtering method and a thick wall printing process which forms the cathode lines 5 by printing and baking a metal paste having the constitution which contains approximately several % to 20% of metal particles and a low-melting-point glass component. In this embodiment, the latter method is adopted.

That is, the cathode lines 5 are formed by printing a silver paste having a large thickness and, thereafter, by baking the printed silver paste at a temperature of 60° C., for example. Here, the silver paste is formed by mixing a low melting-point glass which exhibits the insulation property into conductive silver particles having a particle size of several μm, that is, approximately 1 to 5 μm, for example.

On the other hand, on the cathode lines 5, electron sources 51 which are formed of a diamond film, a graphite film, carbon nanotubes or the like are formed at a given pitch. The detail of connection between the electron sources 51 and the cathode lines 5 is explained in detail in conjunction with FIG. 5 and succeeding drawings later.

Further, above the cathode lines 5 (the face substrate 2 side), the control electrodes 6 which are constituted by arranging a large number of strip-like electrode elements 61 having a plurality of electron passing apertures 6a are arranged close to the cathode lines 5. For example, the control electrodes 6 are arranged close to the cathode lines 5 such that a gap between the electron sources 51 and the electron passing apertures 6a is set to approximately 0.1 mm or less. The cathode lines 5 and the control electrodes 6 face each other in an opposed manner at least over the whole area of the display region AR and the insulation is ensured between the cathode lines 5 and the control electrodes 6. Further, numeral 6b indicates projecting portions formed on the strip-like electrode element 61.

In this embodiment, each electron passing aperture 6a formed in the strip-like electrode element 61 is constituted of a mass of a large number of small electron passing apertures 6an. Further, distal ends of the projecting portions 6b are formed of a sealing material 10 which is of a type substantially equal to the sealing material used for the previously-mentioned hermetic sealing between the support body 3 and both substrates 1, 2 and are fixed to an inner surface of the back substrate 1. This fixing can be performed in the nitrogen atmosphere, for example, at a temperature of 450° C., for example.

The control electrodes 6 described in this embodiment which are constituted by arranging a large number of strip-like electrode elements 61 in parallel are electrodes which are proposed by the inventors of the present invention in the course of development arriving at the present invention. Here, these strip-like electrode terminals 61 are formed of an iron-based stainless steel material or an iron material and have a plate thickness of approximately 0.025 mm to 0.150 mm, for example. The control electrodes 6 are constituted by extending the strip-like electrode elements 61 in the y direction and arranging the strip-like electrode elements 61 in parallel in the x direction.

Further, at the crossing portions of the cathode lines 5 and the plate-like control electrodes 6, the electron sources 51 and the electron passing apertures 6a are arranged to face each other in an opposed manner.

In such a constitution, electrons emitted from the electron sources 51 arranged on the cathode lines 5 receive a control in the electron passing apertures 6a of the control electrodes 6 to which a grid voltage of approximately 100V is applied and, thereafter, pass through the electron passing apertures 6a. Then, the electrons advance toward a phosphor screen 20 to which an anode voltage of several KV to 10 and some KV is applied and penetrate a metal back film 21 (anode) which constitutes the phosphor screen 20 arranged on the face substrate 2 and impinge on a phosphor film 22 thus making the phosphor film 22 emit light whereby a desired display is performed on a video image screen. Here, although not shown in the drawing, the phosphor screen 20 includes black matrix films (BM) and hence, the phosphor screen 20 of this embodiment has the constitution substantially equal to the constitution of a phosphor screen of a conventional color cathode ray tube.

Next, the connecting structure between the cathode lines 5 and the electron sources 51 which are formed on the cathode lines 5 is explained in conjunction with FIG. 5. That is, FIG. 5 is a schematic cross-sectional view showing an essential part of the cathode line, the electron source and the like shown in FIG. 4 in an enlarged manner. The cathode line 5 has the composition in which the property of a connecting portion 5b connected with the electron source 51 is set such that a conductor occupancy rate becomes equal to or more than an insulator occupancy rate.

To explain this composition of the cathode line 5 in detail, as mentioned previously, the cathode line 5 is formed of the silver paste which is produced by mixing the low melting-point glass which exhibits the insulation property into the conductive silver particles having a particle size of several μm, that is, approximately 1 to 5 μm, for example. This silver paste is printed and baked on the back substrate 1 by a thick film printing process, wherein a thick film is formed by baking the silver paste at a temperature of 600° C., for example. Then, a surface of the thick film which constitutes a contact portion 5b with the electron source 51 is etched by chemical etching so as to remove portions or the whole of glass component in the surface whereby the conductor occupancy rate of the connecting portion 5b becomes equal to or more than the insulator occupancy rate thereof. A carbon nanotube paste is printed on a surface of the connecting portion 5b having such a property and the paste is baked at a temperature of 590° C. in a vacuum, for example thus forming the electron source 51.

In this embodiment, as the carbon nanotube paste, a paste which is produced by dispersing single-wall carbon nanotubes into ethylene cellulose and terpineol is used. Although the explanation is made with respect to a case which uses the single-wall carbon nanotubes in the above description, multi-wall carbon nanotubes or carbon nanofibers may be used in place of the single-wall carbon nanotubes. Further, besides the above-mentioned materials, diamond, diamond-like carbon, graphite, amorphous carbon or the like can be used. Still further, it is needless to say that the mixture of these materials can be also used. It is also needless to say that the electron source may contain metal particles such as silver particles or the like or a quantity of insulating material which does not impede the emission of electrons.

By adopting the constitution shown in FIG. 5, in the connecting portion 5b, as described above, the glass component between the silver particles are removed and the conductor is exposed over the substantially whole surface. Accordingly, the conduction between the cathode lines and the electron sources is enhanced such that the conduction is carried out over the substantially whole surface of the connecting portions thus enabling the electron emission from the substantially whole surface of the electron sources and, at the same time, it is possible to obtain the uniform emission quantity for a long period.

In the constitution shown in FIG. 5, the phosphor screen 20 is arranged away from the electron sources 51 by 300 μm in a vacuum and the connection structure is operated by applying a voltage of approximately 900V to the phosphor screen 20. As the result of such an operation, the substantially uniform light emission is obtained and the non-uniform light emission in a mottled pattern is not observed.

Here, in the cathode line 5, the glass component is removed only from the connecting portion which contributes to the connection of the cathode line 5 with the electron source 51 and a desired quantity of glass component is mixed into a portion of the cathode line 4 disposed below the connecting portion and hence, the film per se holds the sufficient rigidity and there is no possibility that an adhesive strength between the cathode line 5 and the back substrate 1 is lowered.

When the display device on which the back substrate 1 having the connecting structure shown in FIG. 5 is mounted is operated with the anode voltage of 7 kV and the grid (control electrode) voltage of 100V (60 Hz driving), all pixels emit the substantially uniform light and exhibit the sufficient brightness necessary as a display and hence, it is confirmed that the display device can be practically used.

FIG. 6 is a schematic cross-sectional view showing an essential part of another embodiment of the display device according to the present invention in an enlarged form and corresponds to FIG. 5. In FIG. 6, numeral 50 indicates a cathode line and numeral 52 indicates a conductor layer. The conductor layer 52 is obtained by applying a paste in which fine silver particles having a particle size of approximately 10 nm, for example are dispersed to the cathode line 50, and by baking the applied paste at a temperature of 350° C., for example. Thus, the conductor layer 52 is formed of only fine silver particles. The use of the fine silver particles is characterized in that the fine silver particles can be sintered by baking at a temperature of at least approximately 300° C., for example, even when a glass component is not contained in the paste. The silver particle layer may be replaced by a fine particle paste which is formed by using other metal such as a fine particle paste made of gold, for example. Further, in the same manner as FIG. 5, a carbon nanotube paste is applied to a surface of the conductor layer 52 and the paste is baked at a temperature of 590° C. in a vacuum thus forming an electron source 51.

On the other hand, the cathode line 50 is formed of the same material as the above-mentioned cathode line 5 and is formed by printing and baking the material. However, the chemical etching treatment is not performed. By interposing the above-mentioned conductor layer 52 between the cathode line 50 and the electron source 51, the substantially whole surfaces of the electron source 51 at the cathode line 50 side is brought into contact with the conductor. Accordingly, it is confirmed that the electron emission can be realized from the substantially whole surface of the electron source 51 and, at the same time, a uniform emission quantity of electrons can be obtained for a long time.

That is, in the constitution shown in FIG. 6, the phosphor screen 20 is arranged away from the electron sources 51 by 300 μm in a vacuum and the connection structure is operated by applying a voltage of approximately 900V to the phosphor screen 20. As the result of such an operation, the substantially uniform light emission is obtained and the non-uniform light emission in a mottled pattern is not observed and hence, the advantageous effect of the present invention is proved.

On the other hand, the above-mentioned glass component exists in a connecting portion between the conductor layer 52 and the cathode line 50. However, provided that the conduction between them is ensured at some portions of the connecting portion, the function can be achieved and hence, the interposition of the glass component does not cause any problem. Further, the cathode line 50 per se is formed of the silver paste which mixes the low melting-point glass which exhibits the insulating property into the conductive silver particles as mentioned previously. Accordingly, compared to a case in which both films formed of the cathode line 50 and the conductor layer 52 are integrally formed of only the above-mentioned fine silver particles, it is possible to manufacture the connecting structure at a low cost and, at the same time, there is no possibility that the adhesive strength between the cathode line 50 and the back substrate 1 is lowered.

Here, it is needless to say that another conductor layer may be interposed between the cathode line 50 and the conductor layer 52 or between the cathode line 50 and the back substrate 1.

Further, although the explanation is made with respect to the case in which the cathode line is formed of the silver paste heretofore, it is needless to say that the cathode line is formed by using other metal particles such as gold particles, nickel particles or the like, for example. Further, although a non-photosensitive paste is used as the silver paste, a photosensitive paste may be used as the silver paste. Still further, it is needless to say that the present invention is also applicable to the constitution which obtains the cathode line and the electron sources by patterning using a photolithography process.

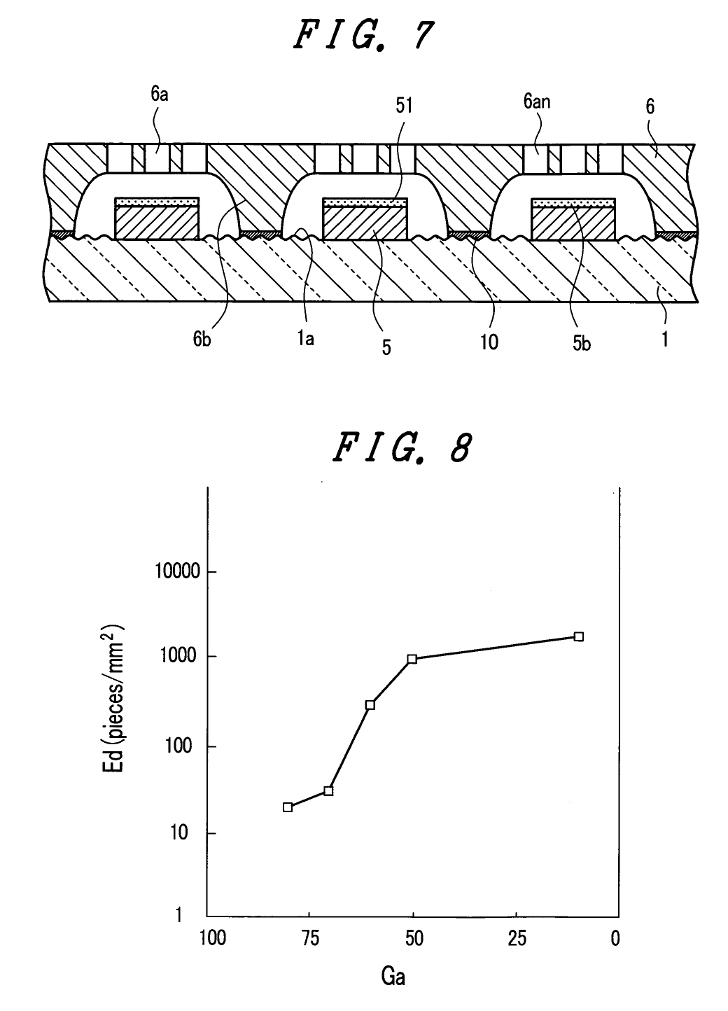

Next, FIG. 7 is a schematic cross-sectional view showing an essential part of another embodiment of the display device according to the present invention in an enlarged form. In the drawing, numerals equal to the numerals used in FIG. 1 to FIG. 6 indicate the identical functional portions. In FIG. 7, numeral 1a indicates an inner surface of a back substrate 1 and the inner surface 1a exhibits an uneven shape. That is, the uneven shape is formed by removing the portions of the glass component on the surface simultaneously when the chemical etching treatment is applied to the glass component in the connecting portion 5b of the cathode line 5 explained in conjunction with FIG. 5. In this manner, by forming the uneven shape on the inner surface 1a of the back substrate 1, in addition to the advantageous effect explained in conjunction with FIG. 5, it is possible to increase the mutual creeping distance between the neighboring electrodes whereby the enhancement of the dielectric strength can be achieved.

Here, it is needless to say that the uneven shape may be formed before applying the cathode lines 5 on the inner surface 1a of the back substrate 1 or may be formed by a known processing method other than the chemical etching. Further, by preliminarily forming the whole surface of the inner surface 1a of the back substrate 1 into the uneven shape and, thereafter, by forming the cathode lines 5 and the like, it is possible to obtain an advantageous effect that the adhesive strength for adhering the inner surface 1a of the back substrate 1 with the electrodes to be mounted on the inner surface 1a can be further enhanced.

Next, FIG. 8 is a view showing the relationship between the property and the light emitting uniformity of the connecting portion of the cathode line of one embodiment of the display device according to the present invention. In the drawing, a glass occupancy rate (area ratio) Ga (%) in the composition of the connecting portion of the cathode line is taken on an axis of abscissas and an electron emission site density Ed (pieces/mm²) which becomes an index of the light emission uniformity is taken on an axis of ordinates.

In FIG. 8, first of all, the cathode lines are formed using the above-mentioned silver paste which is usually used, that is, the silver paste which contains the silver particles and the low melting-temperature glass is formed. The glass occupancy rate (area ratio) Ga (%) of the connecting portion of the cathode line is 80%. Subsequently, the glass component is gradually expelled from the surface which constitutes the connecting portion of the cathode line with the electron source and, then, the electron source is formed on the surface. Thereafter, the electron emission site density Ed with respect to the glass occupancy rate Ga is measured. The expulsion of the glass component is performed by the removal of silver oxide on the surface of the silver particles in a lift-off manner.

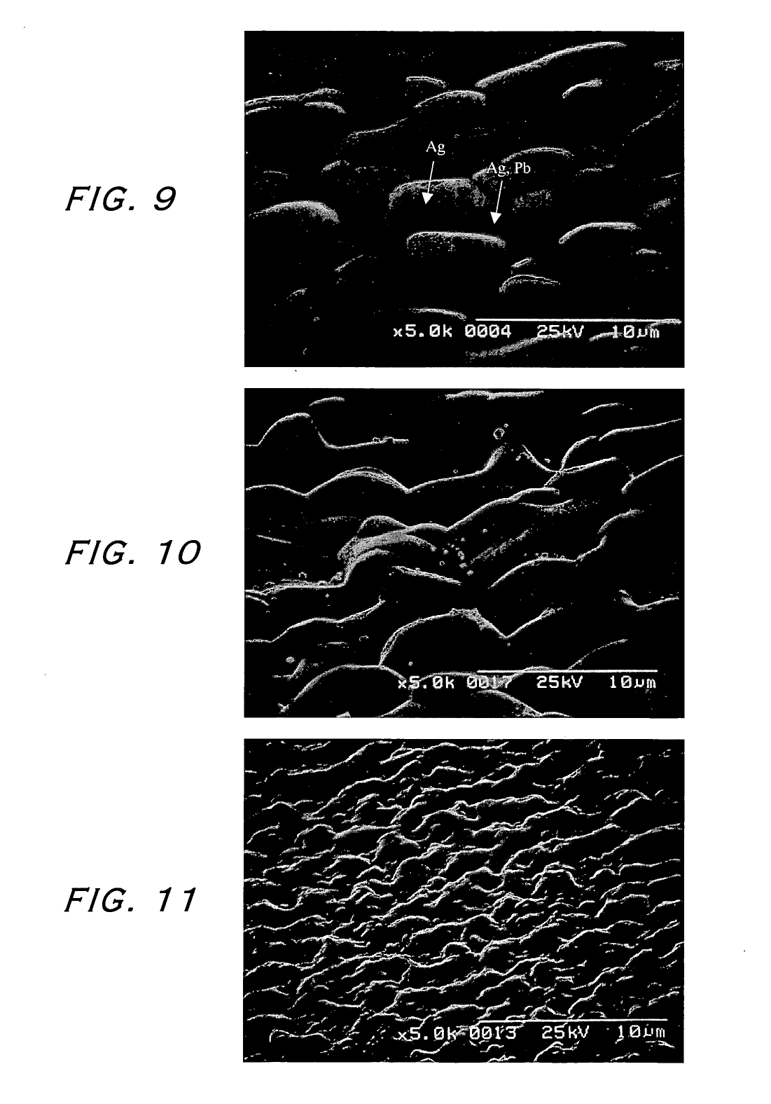

That is, the surface of the cathode line which is formed by printing and baking the silver paste has, as indicated in a SEM photograph shown in FIG. 9, the constitution in which the melted glass surrounds peripheries of silver particles or lead particles in the low melting-temperature glass. The cathode line having such a surface condition is treated in a lift-off manner as described above to expel the glass component using thiourea system chemicals (for example, ESCREEN AG-301, a product of Sasaki Kagaku Yakuhin Kabushiki Kaisha). FIG. 10 is a SEM photograph showing the surface of the cathode line after the treatment. As can be understood from the SEM photograph, in the surface which constitutes the connecting portion, only the glass component between the silver particles is removed.

Next, the measurement of the electron emission site density is performed by an emission profiler having minute apertures in a measuring anode (for example, a product of Tokyo cathode Ltd.) under conditions where an aperture diameter is set to 10 μm, a distance between the anode and an electron source is set to 50 μm, and a measuring step is set to 10 μm. As can be understood from FIG. 8, it is found that when the glass occupancy rate Ga is lowered to a value below 50% as the result of the gradual expulsion of the glass component from the surface which constitutes the connecting portion 5b of the cathode line 5 with the electron source 51, the light emitting brightness can obtain the practically sufficient electron emission site density. Although the electron emission site density rapidly changes when the glass occupancy rate is in a range of 70% to 50%, there exists a possibility that the light emitting brightness becomes insufficient when the glass occupancy rate is 60%. Accordingly, it is important from a practical point of view that the glass occupancy rate is below 50%.

On the other hand, when the glass occupancy rate is 50% or below, as shown in the drawing, it is possible to ensure the sufficient electron emission site density. However, even when the glass occupancy rate is 50% is lowered to approximately 10%, the difference in the electron emission site density between the case in which the glass occupancy rate is 50% and the case in which the glass occupancy rate is 10% is extremely small and hence, the glass occupancy rate may be determined based on the balance between a treatment operation amount for expelling the glass component and the electron emission site density.

Next, FIG. 11 is a SEM photograph showing a surface of the conductor layer 52 which is interposed between the cathode line 50 and the electron source 51 having the constitution shown in FIG. 6 and has the whole thereof formed of only fine silver particles. To compare the surface state indicated in FIG. 11 and the previously-mentioned surface state indicated in FIG. 9, the difference is evident. That is, it is possible to confirm with naked eyes that the surface of the conductor layer 52 is covered with a silver film which hardly contains the glass component. Accordingly, by merely applying the electron source 51 such as carbon nanotubes, for example, to the cathode line without affording any treatment to the surface of the conductor layer 52, the substantially uniform electron emission can be performed from the whole surface of the electron sources and hence, the desired display is obtained.

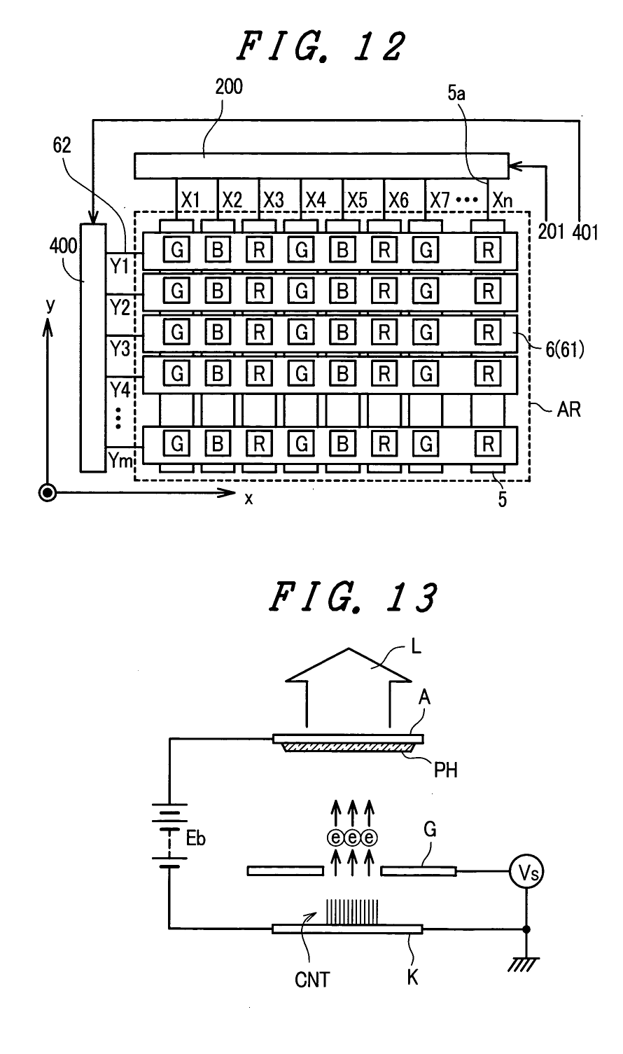

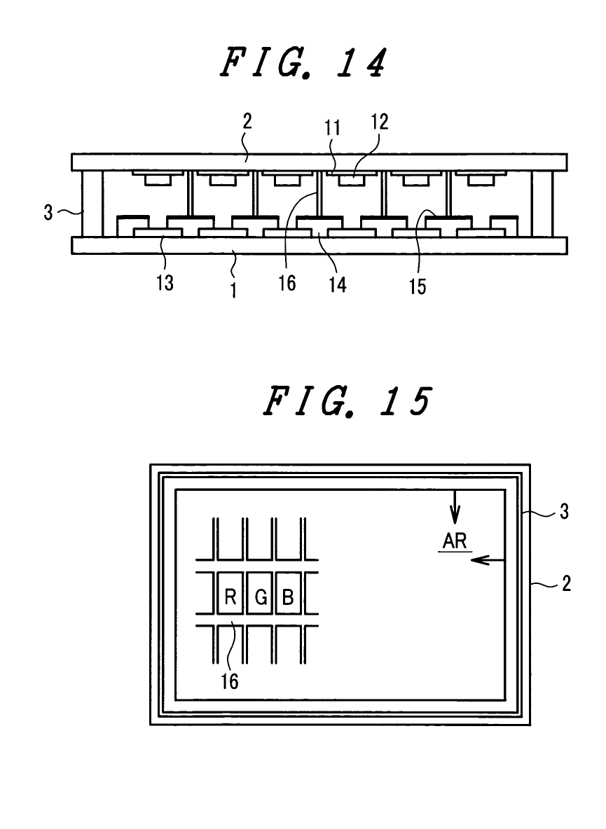

Next, FIG. 12 is an explanatory view of an example of an equivalent circuit of the display device of the present invention. A region indicated by a broken line in the drawing indicates a display region AR. In the display region AR, the cathode lines 5 and the control electrodes 6 (strip-like electrode elements 61) are arranged to cross each other thus forming a matrix of n×m. Respective crossing portions of the matrix constitute unit pixels and one color pixel is constituted of a group of “R”, “G”, “B” in the drawing. The cathode lines 5 are connected to a video drive circuit 200 through the cathode line lead lines 5a (X1, X2, . . . Xn), while the control electrodes 6 are connected to a scanning drive circuit 400 through control electrode lead lines 62 (Y1, Y2, . . . Ym). The video signals 201 are inputted to the video drive circuit 200 from an external signal source, while scanning signals (synchronous signals) 401 are inputted to the scanning drive circuit 400 in the same manner.

Accordingly, the given pixels which are sequentially selected by the strip-like electrode elements 61 and the cathode lines 5 are illuminated with lights of given colors so as to display a two-dimensional image. With the provision of the display device having such a constitutional example, it is possible to realize a flat panel type display device which is operated by a relatively low voltage and hence exhibits high efficiency.

As has been explained heretofore, by constituting the connecting portion of the cathode line with the electron source such that the conductor occupancy rate becomes equal to or more than the insulator occupancy rate, the electron emission from the whole surface of the electron source can be performed and, at the same time, the uniform emission quantity can be obtained for a long time whereby it is possible to provide the display device which can perform the high quality display and has a long lifetime.

Further, by interposing the layer in which the conductor exhibits the high occupancy rate in the connecting portion between the cathode line and the electron source, the electron emission from the whole surface of the electron source can be performed and, at the same time, the uniform emission quantity can be obtained for a long time. Further, the adhesive strength between the back substrate and the cathode line can be sufficiently ensured whereby it is possible to provide the display device which is capable of exhibiting the high quality display and has a long lifetime.

What is claimed is:

1. A display device comprising:
a face substrate which forms anodes and phosphors on an inner surface thereof;
a plurality of cathode lines which extend in one direction and are arranged in parallel in another direction which crosses one direction;
a plurality of electron sources which are arranged on the cathode lines in an electrically conductive manner;
control electrodes which face the cathode lines in a display region and have electron passing apertures for allowing electrons from the electron sources to pass through the electron passing apertures to the face substrate side;
a back substrate which forms the control electrodes and the cathode lines on an inner surface thereof and faces the face substrate in an opposed manner with a given distance therebetween;
a support body which is interposed between the face substrate and the back substrate in a state that the support body surrounds the display region and holds the given distance; and
a sealing material which hermetically seals end faces of the support body and the face substrate and the back substrate respectively, wherein
a connecting portion of the cathode line with the electron source has a composition which includes a conductor and an insulator, and the composition is determined such that an occupancy rate of the conductor is set equal to or more than an occupancy rate of the insulator.

2. A display device according to claim 1, wherein the occupancy rate of the insulator is less than 50%.

3. A display device according to claim 1, wherein a surface of the back substrate in the vicinity of the cathode lines exhibits an uneven shape.

4. A display device comprising:
a face substrate which forms anodes and phosphors on an inner surface thereof;
a plurality of cathode lines which extend in one direction and are arranged in parallel in another direction which crosses one direction;
a plurality of electron sources which are arranged on the cathode lines in an electrically conductive manner;
control electrodes which face the cathode lines in a display region and have electron passing apertures for allowing electrons from the electron sources to pass through the electron passing apertures to the face substrate side;
a back substrate which forms the control electrodes and the cathode lines on an inner surface thereof and faces the face substrate in an opposed manner with a given distance therebetween;
a support body which is interposed between the face substrate and the back substrate in a state that the support body surrounds the display region and holds the given distance; and
a sealing material which hermetically seals end faces of the support body and the face substrate and the back substrate respectively, wherein
a layer in which an occupancy rate of a conductor is high is interposed in a connecting portion between the cathode line and the electron source.

5. A display device according to claim 4, wherein the layer in which the occupancy rate of the conductor is high is either a silver particle layer or a gold particle layer.
